(19) United States
(12) Patent Application Publication
(10) Pub. No.: US 2003/0080273 A1
(43) Pub. Date: May 1, 2003

(54) Optical disk apparatus and method of recording/reproducing thereof

(75) Inventor: Kiyoshi Hibino, Gifu (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: SANYO ELECTRIC CO., LTD.

(21) Appl. No.: 10/284,090

(22) Filed: Oct. 31, 2002

(30) Foreign Application Priority Data
Oct. 31, 2001 (JP) 2001-335160

(51) Int. Cl. G02B 7/04; G02B 27/40

(52) U.S. Cl. 250/201.5

(57) ABSTRACT

An optical disk apparatus includes a laser diode, and a light from the laser diode becomes a parallel light by a collimator lens, which is reflected toward an object lens by a reflection mirror, and focused on a disk through the object lens. A reflected light from the disk is incident on a light-receiving sensor via the collimator lens and a polarization beam splitter. A disk tilt or a lens tilt that renders an amplitude of a push-pull signal of the light-receiving sensor maximum at an arbitrary radial location of the disk is detected. Furthermore, in recording or reproducing the signal, a tilt amount of the disk or the lens (inclination angle) in accordance with the radial location as of that time is set.

### BACKGROUND OF THE INVENTION

1. Field of the Invention

The present invention relates to an optical disk apparatus and a method of recording/reproducing in an optical disk apparatus. More specifically, the present invention relates to an optical disk apparatus and a method of recording/reproducing that detect a tilt (inclination) in a radial direction of an optical disk such as a DVD, a CD, and so on or an object lens so as to alleviate an influence of the radial tilt.

2. Description of the Prior Art

With an increased recording capacity of an optical disk and its enhanced recording density, a beam spot which irradiates to the optical disk is becoming minute in order to reproduce or record a signal. More specifically, in an optical disk apparatus which performs a recording, a minute beam spot is required than a reproduction-use optical disk apparatus in order to record a signal in a good condition. To obtain the minute spot, an object lens with large numerical apertures is adopted, and consequently, a side effect occurs, in which a deteriorated level of a spot quality by the disk tilt becomes evident.

The deteriorated level of a spot quality by the disk tilt mainly means a generation of a comatic aberration, that is, as a result of a blurred imagery, a spot size becomes large, and its central optical intensity deteriorates in addition thereto. If the spot size becomes large, a minute signal is not read out appropriately. In a case of the optical disk on a principal that a recording is performed by an optical heat, a decrease in the central optical intensity results in its temperature not reaching a predetermined value required for the recording, thus not possible to record. On the other hand, if an entire amount of light is increased in order to obtain the predetermined temperature, an area above the predetermined temperature expands, thus not possible to record minutely.

The disk tilt is a state produced in a case of using a disk with a large curvature. A state that a portion to which a beam irradiates is radially tilted toward the disk is referred to as a radial tilt, and a state tangentially tilted is referred to as a tangential tilt.

Referring to FIG. 1 and FIG. 2, a prior art 1 in which such the disk tilt is detected and modified is described. In FIG. 1, a disk 1, that is, a recording and reproducing body is held by a holding portion 2, rotated by a spindle motor 3a, and irradiated from an optical pick-up 4, thereby recording a signal on the disk 1 or reproducing the signal from the disk 1. An optical pick-up 4 is held by a shaft 5a, and the shaft 5a is held by a shaft holder 5b. The shaft holder 5b is fixed on a shaft holder chassis 5c. It is noted that the above-described spindle motor 3a is fixed on a spindle motor chassis 3b, and the spindle motor chassis 3b and the shaft holder chassis 5c are joined by a holding axis 6. In addition, a cam 7 which oscillates an edge of the shaft chassis 5c up and down is provided on the spindle motor chassis 3b.

It is noted that as shown in FIG. 2, a tilt sensor 8 which detects the tilt of the disk 1 is provided inside the optical pick-up 4. The tilt sensor 8 is an electronic part in which a light emitted from an interval LED is reflected on a reflection surface horizontal to a sensor-providing surface, and the reflected light, taking an outputted electronic signal in accordance with a position which falls on an internal light-receiving sensor as a reference, detects that the position which falls on the internal light-receiving sensor is slipped by a change of the output signal when the reflection surface is tilted, and consequently, the tilt on the reflection surface is detected.

The light emitted from the optical pick-up 4 is focused in imagery on the disk 1 rotated by the spindle motor 3a so as to form a minute spot. The optical pick-up 4 moves along the shaft 5a by a driving portion (not shown). Therefore, the spot is capable of scanning in a two-dimensional manner on the disk 1. This allows the optical pick-up 4 to record a signal on a signal surface provided at a depth of an inner side via a transparent cover glass layer from a surface of the disk 1, and reproduce the signal from the signal surface.

Next, descriptions are made with respect to an operation of a state that a shape of the disk 1 has a predetermined gradient toward a radial direction or in a state that the gradient is gradually changing along with a radius and a case that such the disk 1 is attached to an apparatus.

The tilt sensor 8 detects a radial tilt amount. The cam 7 is rotated by a driving source not shown, and oscillates the edge of the shaft holder chassis 5c up and down. As the result, the optical pick-up 4 attached on the chassis 5c, using the axis 6 as its center, changes the gradient. It is possible to stop the cam7 by detecting a relative angle with the disk 1 by the tilt sensor 8 while changing the gradient of the optical pick-up 4 in such a state that the optical pick-up 4 and the disk 1 maintain a parallel relationship with each other. This solves the comatic aberration from the spot on the disk 1. That is, in the prior art, the gradient of the optical disk 4 is changed in accordance with the disk tilt amount detected by the tilt sensor 8 so as to compensate the disk tilt.

The method of the prior art requires an additional (extra) tilt sensor, thus its cost increases, and in addition, it also places a restraint on miniaturization.

### SUMMARY OF THE INVENTION

Therefore, it is a primary object of the present invention to provide a novel optical disk apparatus.

It is another object of the present invention to provide an optical disk apparatus that requires no additional or extra detection-use parts, and in addition, is capable of being applied to disks in comprehensive physical formats.

A first invention is an optical disk apparatus provided with an optical pick-up that irradiates a beam spot onto a disk through an object lens, receives a reflected light from the disk by a two-divided light-receiving element, and has a function that detects a difference signal of electrical outputs reflecting light-receiving amounts of the respective light-receiving elements, and a mechanism capable of changing a relative angle of the disk toward the object lens in a radial direction of the disk, characterized in the apparatus further comprises a detection means that evaluates a gradient angle of the disk at which an amplitude of the difference signal is rendered maximum in an arbitrary radial location.

In addition, the optical disk apparatus further comprises an angle setting means that sets a gradient angle of the disk in accordance with a radius that intends to perform a recording/reproducing the signal on the basis of the radial location and the gradient angle of the disk.

A second invention is an optical disk apparatus provided with an optical pick-up that irradiates a beam spot onto a disk through an object lens, receives a reflected light from the disk by a two-divided light-receiving element, and has a function that detects a difference signal of electrical outputs reflecting light-receiving amounts of respective light-receiving elements, and a function capable of changing a gradient angle of the object lens in a radial direction of the disk, characterized in that the apparatus further comprises a detection means that evaluates the gradient angle of the object lens at which an amplitude of the difference signal is rendered maximum in an arbitrary radial location.

In addition, the optical disk apparatus further comprises an angle setting means sets a gradient angle of the object lens in accordance with a radius that intends to perform a recording/reproducing the signal on the basis of the radial location and the gradient angle of the object lens.

A third invention is a method of recording/reproducing a signal in an optical disk apparatus provided with an optical pick-up that irradiates a beam spot onto a disk through an object lens, receives a reflected light from the disk by a two-divided light-receiving element, and has a function that detects a difference signal of electrical outputs reflecting light-receiving amounts of the respective light-receiving elements, and a function capable of changing a relative angle of the disk toward an object lens in a radial direction of the disk, includes following steps of (a) evaluating a gradient angle of the disk at which an amplitude of the difference signal is rendered maximum in an arbitrary radial location, and (b) setting the gradient angle of the disk in accordance with a radius that intends to perform a recording/reproducing a signal on the basis of the radial location and the gradient angle of the disk.

A fourth invention is a method of recording/reproducing a signal in an optical disk apparatus provided with an optical pick-up that irradiates a beam spot onto a disk through an object lens, receives a reflected light from the disk by a two-divided light-receiving element, and has a function that detects a difference signal of electrical outputs reflecting light-receiving amounts of each light-receiving element, and a function capable of changing a gradient angle of the object lens in a radial direction of the disk, includes following steps of (a) evaluating a gradient angle of the object lens at which an amplitude of the difference signal is rendered maximum in an arbitrary radial location, and (b) setting the gradient angle of the disk in accordance with a radius that intends to perform a recording/reproducing a signal on the basis of the radial location and the gradient angle of the object lens.

In a case of performing a tilt control of the disk as in the first invention or the third invention, the pick-up is caused to move toward the radial direction at such intervals that a state of a curvature of the disk is recognizable between an inner most periphery and an outer most periphery of the disk. At this time, a focus servo activates in such a manner that the beam spot on the disk is being focused. On the other hand, a tracking servo is not activated, and the beam spot is in a state of not following a groove or a pit array, and traversing them due to an eccentricity of the disk.

An amplitude of a push-pull signal is measured in a certain radial location in a state that the disk is not to be slanted. Then, the push-pull signal amplitude is measured while the disk is slanted toward both forwarding and reverse directions in the radial direction of the disk from the state that the disk is not to be slanted. On the basis thereof, a disk angle at which the push-pull signal amplitude is rendered maximum or a physical amount equivalent thereto is assumed.

Then, a pair data cluster of each radius and the disk angle at which the push-pull signal amplitude is rendered maximum or the physical amount equivalent thereto is obtained. In recording or reproducing the signal in an arbitrary radial location, the disk angle at which the push-pull signal amplitude is rendered maximum or the physical amount equivalent thereto is assumed from the data cluster. Or the disk angle at which the push-pull signal amplitude in the radius is rendered maximum or the physical amount equivalent thereto is assumed by using data in place thereof, which is in a nearest radial location from the arbitrary location.

In recording and reproducing the signal, the recording and the reproducing are performed by setting the gradient of the disk in the radial location in such a manner that the angle of the disk at which the push-pull signal amplitude is rendered maximum or the physical amount equivalent thereto is obtained.

In a case of performing the tilt control of the object lens as in the second invention or the fourth invention, the pick-up is caused to move toward the radial direction at such intervals that a state of a curvature of the disk is recognizable between a inner most periphery and an outer most periphery of the disk. At this time, a focus servo activates in such a manner that the beam spot on the disk is being focused. On the other hand, a tracking servo is not activated, and the beam spot is in a state of not following a groove or a pit array, and traversing them due to an eccentricity of the disk.

An amplitude of a push-pull signal is measured in a certain radial location in a state that the object lens is not to be slanted. Then, the push-pull signal amplitude is measured while the object lens is slanted toward both forwarding and reverse directions in the radial direction of the object lens from the state that the object lens is not to be slanted. On the basis thereof, an angle of the object lens at which the push-pull signal amplitude is rendered maximum or a physical amount equivalent thereto is assumed.

A pair data cluster of each radius and the disk angle at which the push-pull signal amplitude is rendered maximum or the physical amount equivalent thereto is obtained. When recording or reproducing the signal in an arbitrary radial location, the disk angle at which the push-pull signal amplitude is rendered maximum or the physical amount equivalent thereto is assumed from the data cluster. Or the disk angle at which the push-pull signal amplitude in the radius is rendered maximum or the physical amount equivalent thereto is assumed by using data in place thereof, which is in a nearest radial location from the arbitrary location.

In recording and reproducing the signal, the recording and the reproducing are performed by setting the inclination of the object lens in the radial location in such a manner that the angle of the object lens at which the push-pull signal amplitude is rendered maximum or the physical amount equivalent thereto is obtained.

According to the present invention, no additional or extra detection-use parts are employed, thus possible to perform the tilt control by a small-sized pick-up, not rendering the entire pick-up large.

In addition, it is possible to apply on condition that it be a disk that produces a push-pull signal even if the disk has a guide groove or the disk has pit arrays only, thus possible to apply to disks of comprehensive physical formats.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing a conventional optical disk apparatus except for a control circuit portion;

FIG. 2 is an illustrative view showing structure of an optical pick-up of FIG. 1 conventional apparatus;

FIG. 3 is an illustrative view showing one embodiment of the present invention except for an control circuit portion;

FIG. 4 is an illustrative view showing structure of an optical pick-up of FIG. 3 embodiment;

FIG. 5 is an illustrative view showing sub-beams in FIG. 4 optical system;

FIG. 6 is an illustrative view showing the sub-beam on a yz plane of FIG. 4 optical system;

FIG. 7 is an illustrative view showing the sub-beam on a xy plane of FIG. 4 optical system;

FIG. 8 is an illustrative view showing a divided arrangement of a light-receiving sensor in FIG. 3 embodiment;

FIG. 9 is an illustrative view showing a state of a light beam from an object lens to a disk in a case of absence of a disk tilt;

FIG. 10 is an illustrative view showing a focus spot on a disk signal surface observed from an opposite side toward the object lens in FIG. 9;

FIG. 11 is an illustrative view showing a state of the light beam from the object lens to the disk in a case of presence of the disk tilt;

FIG. 12 is an illustrative view showing the focus spot on the disk signal surface observed from an opposite side toward the object lens in FIG. 11;

FIG. 13 is an illustrative view showing a state of the light beam from the object lens to the disk in a case of absence of an object lens tilt;

FIG. 14 is an illustrative view showing a focus spot on the disk signal surface observed from an opposite side toward the object lens in FIG. 13;

FIG. 15 is an illustrative view showing a state of the light beam from the object lens to the disk in a case of presence of the object lens tilt;

FIG. 16 is an illustrative view showing the focus spot on the disk signal surface observed from an opposite side toward the object lens in FIG. 15;

FIG. 17 is an illustrative view showing a state of the light beam from the object lens to the disk in a case of absence of an optical tilt;

FIG. 18 is an illustrative view showing a state of the light beam from the object lens to the disk in a case of presence of an optical tilt;

FIG. 19 is an illustrative view showing a state of a cross section of a disk and a light ray in a case that neither the disk nor the object lens is tilted;

FIG. 20 is an illustrative view showing a state of a cross section of the disk and the light ray in a case that the disk is tilted;

FIG. 21 is an illustrative view showing an optical disk apparatus of another embodiment of the present invention;

FIG. 22 is an illustrative view showing a state of a cross section of a disk and a light ray in a case that the object lens is tilted; and

FIG. 23 is an illustrative view showing a state of a cross section of a disk and a light ray in a case that the object lens is slanted in such a manner that a comatic aberration produced as a result of the disk being tilted is compensated or canceled.

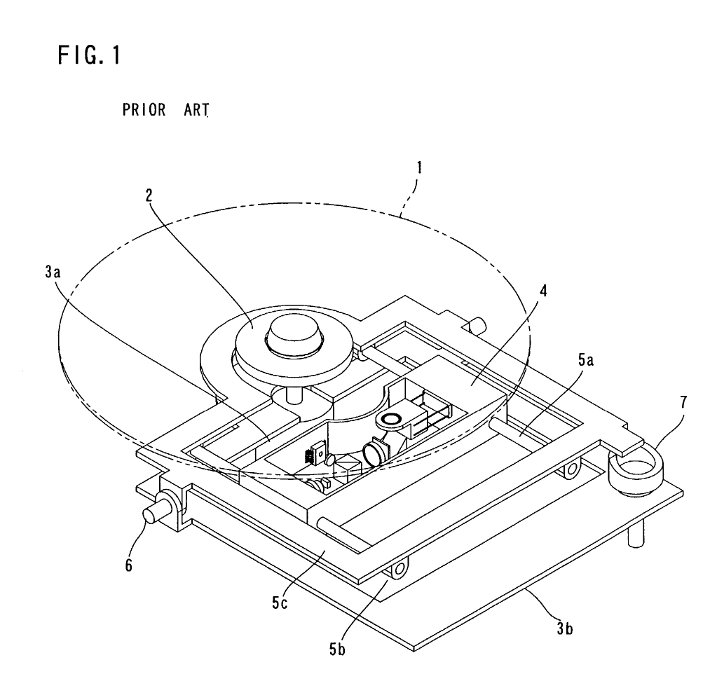

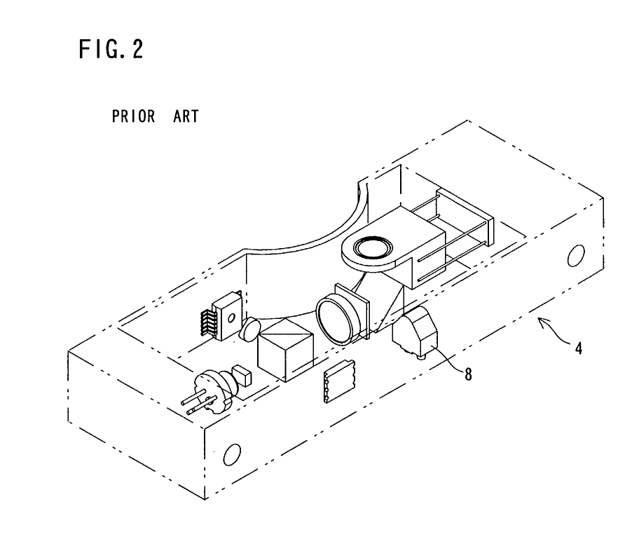

### DETAILED DESCRIPTION OF THE PREFERRED EMBODIMENTS

[The First Embodiment]

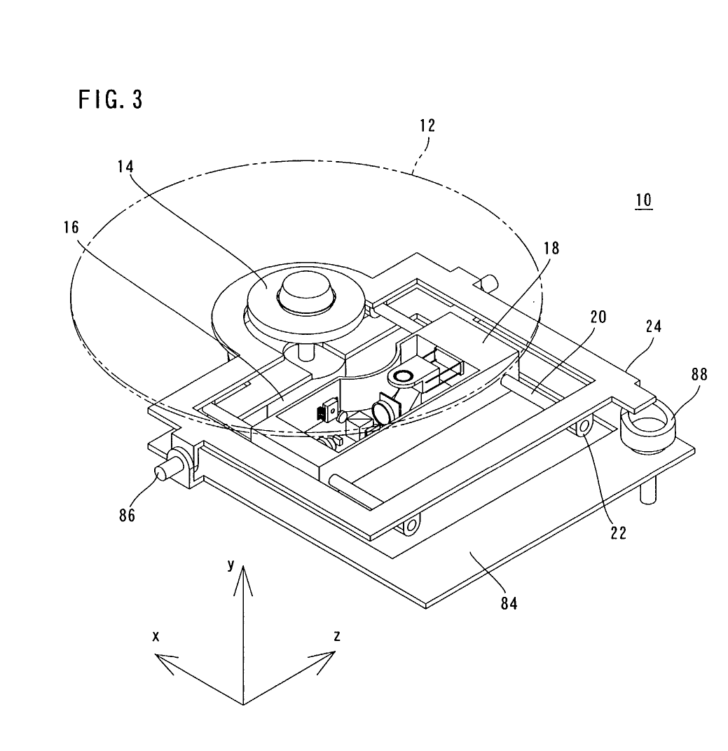

Referring to FIG. 3, an optical disk apparatus 10, which is one embodiment of the present invention, uses a disk 12 such as a DVD-R/RW or the like, for example as a means that records and reproduces a signal. It is noted that in order that lower structural parts of the disk 12 are clearly specified, only an outer form of the disk 12 is illustrated by an imaginary line in FIG. 3. The disk 12 is held by a holding portion 14, and rotated by a spindle motor 16. Below the disk 12, provided is an optical pick-up 18 for recording a signal to the disk 12 and reproducing a signal from the disk 12, and the optical pick-up 18 is held by a shaft 20 in such a manner as to be movable toward an axial direction of the shaft 20. In addition, the shaft 20 is held by a shaft holder 22, and the shaft holder 22 is fixed on a chassis 24, together with the spindle motor 16.

The aforementioned spindle motor 16 is fixed onto a spindle motor chassis 84, and the spindle motor 84 and the shaft holder chassis 24 are joined by a shaft 86. In addition, a cam 88 which oscillates an edge of the shaft holder chassis 24 up and down is provided on the spindle motor chassis 84.

Although not shown, a transparent cover glass layer is formed on a surface of the disk 12, and a signal is recorded in accordance with a well-known method on a signal surface which is a hierarchical lower layer thereof. There are well-known signal recording methods such as a method by a pit which is a minute concave and convex, a method which performs a recording by allowing a difference in refraction and reflectivity, a method which performs a recording by allowing a difference in magnetopolarity, and so on. The present invention can be applied to a physical format of such an arbitrary optical disk. However, since such the kinds of various recording and reproducing principles are well known, its descriptions are herein omitted.

A light emitted from the optical pick-up 18 is focused on a signal surface of the disk 12, and forms a minute spot. The optical pick-up 18 is moved by a driving portion (not shown) along the shaft 20. Thus, the spot by the optical pick-up 18 is scanned in a two-dimensional manner on the disk 12. The signal is recorded on a signal surface of the disk 12 by an irradiation of the spot, and in addition, the signal is reproduced by the light irradiated onto the signal surface.

Although structure of an optical system to which the present invention is applied slightly differs depending on a difference of the above-described recording and reproducing methods, in FIG. 3 embodiment, an optical system of a case the disk 12 is a DVD-R/RW. However, the present invention is not limited thereto.

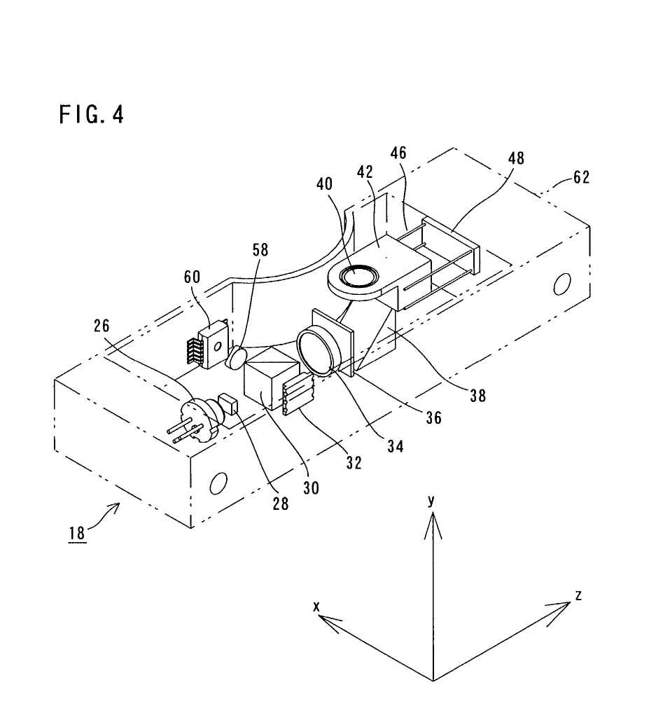

As shown in FIG. 4, inside a housing 62 of the optical pick-up 18, provided is a laser diode 26 which is a light source for recording and reproducing the signal, and a light from the laser diode 26 is incident on a diffraction grating 28. The diffraction grating 28 divides the incident light in three, and irradiates them into a polarizing beam splitter 30. The polarizing beam splitter 30 reflects or transmits the light in accordance with its polarization. On a side surface of its front side of the polarizing beam splitter 30, provided is a front monitor 32 for detecting an amount of light. In addition, at a front of the polarizing beam splitter 30, provided is a collimator lens 34 for converting a radiant light into a parallel light, and the light transmitted through the collimator lens 34 is applied to a 1/4 (quarter) wave plate 36 which performs a conversion of a linearly polarized light and a circularly polarized light.

The light emitted from the 1/4 wave plate 36 is reflected by a reflection mirror 38, and focused on the disk 12 through an object lens 40. The object lens 40 is fixedly held by an object lens holder 42. The object lens holder 42 is held by a wire suspension 46, and the wire suspension 46 is held by a wire suspension plate 48.

In addition, as well understood from FIG. 4, a cylindrical lens 58 for producing an astigmatism is provided on a side surface at a rear surface side of the polarizing beam splitter 30a. A light-receiving sensor 60 receives a light from the cylindrical lens 58, and converts the light into an electronic signal (current or voltage).

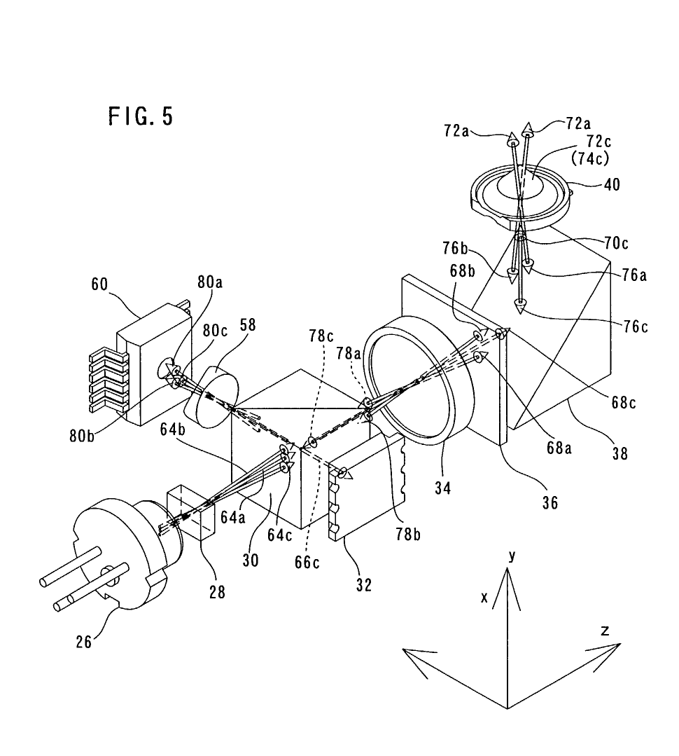

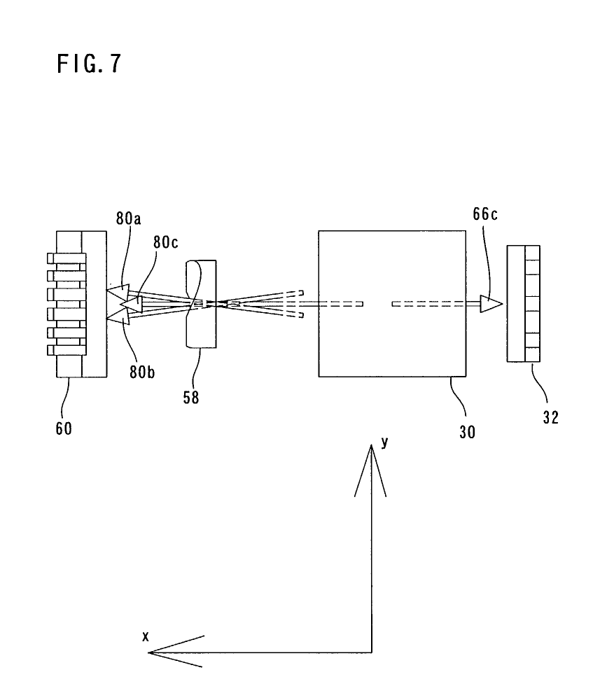

Herein, a flow of a light used for a normal signal reproduction is described using FIG. 5-FIG. 7.

Lights 64a, 64b and 64c radially emitted from the laser diode 26 are spherical waves, and divided into three spherical waves each of which has a virtual light source by transmitting through the diffraction grating 28. The light 64c is a principal ray of a zero-order light using a light source of the laser diode 26 on the optical axis of the collimator lens 34. The light 64a and the light 64b are symmetrical with respect to the optical axis, and a principal ray of + (plus) primary light and − (minus) primary light having a virtual light source within a yz plane. The zero-order light becomes a main beam with a large amount of light, and used for recording and reproducing the signal. The ± primary light becomes two sub-beams with a small amount of light, and used for a tracking servo called as a differential push-pull method.

Firstly, a flow of the zero-order light is described. The polarizing beam splitter 30 divides a P wave component of the light into a spectrum of a transmitted light and a reflected light at a predetermined ratio such as 9:1, for example, and divides an S wave component into the spectrum of the transmitted light and the reflected light at a predetermined ratio such as 0:10, for example. In this optical system, since a plane of polarization of the linearly polarized light of the laser diode 26 is arranged to be parallel to the zx plane, all lights emitted from the laser diode 26 are rendered a P wave. Therefore, 1/10 of the entire amount of light is reflected, and irradiated on the front monitor 32 as a light 66c, and a remaining light 68c is transmitted.

The light 66c being incident to the front monitor 32 is converted into an electronic signal to be utilized for an automatic power control. An electronic signal in accordance with a difference between an electronic signal corresponding to a target amount of light and an output of the front monitor 32 is applied to a control circuit, e.g. a laser driver IC, and a current supplied to the laser diode 26 is controlled in such a manner that the electronic signal is kept at a predetermined value by a servo circuit (not shown) which thereby changes a value of the current supplied to the laser 26. Consequently, a main beam 70c emitted from the object lens 40 is kept at a predetermined optical power.

The light 68c transmitted through the polarizing beam splitter 30 is converted by the collimator lens 34 from a spherical wave to a plane wave, in other word, from a radiant light to a parallel light. The direction is parallel to the optical axis.

The parallel light converted by the collimator lens 34 is incident on the 1/4 wave plate 36, and thereby, the linearly polarized light is converted into the circularly polarized light. The circularly polarized light means a state that a phase of the P wave and the S wave of the light are deviated from each other by a 1/4 wavelength. In addition, the light 68c changes its direction on the reflection mirror 38, and is incident on the object lens 40 as a light 70c. The light 70c is focused on the signal surface of the disk 12 (light 72c), and reflected (light 74c). At this time, since the phase of the light is reversed by the reflection, in other words, the phase is changed by a 1/2 wavelength, a relationship of order of the P wave and the S wave having the phase deviated by 1/4 wavelength is reversed. That is, a rotation direction of the circularly polarized light is reversed.

The reflected light flows back an approaching route, and firstly transmits the 1/4 wave plate 36 (light 78c) after being converted by the object lens 40 into a parallel light 76c. At this time, the reflected light is converted from the circularly polarized light to the linearly polarized light. However, unlike an approaching route, since the direction of the circularly polarized light is reversed, a polarization plane of the converted linearly polarized light is rendered parallel to an S wave plane in the polarizing beam splitter 30, that is, rendered parallel to the yz plane.

Next, the parallel light from the 1/4 wave plate 36 is converted into a convergent light in the collimator lens 34, and incident on the polarizing beam splitter 30 as a light 78c. Since the light 78c is linearly polarized into the S wave, the light 78c is wholly (100%) reflected in the polarizing beam splitter 30, and a reflected light 80c changes its direction toward the light-receiving sensor 60.

The light 80c headed for the light-receiving sensor 60 is incident to the cylindrical lens 58. An edge line of the cylindrical lens 58 is tilted at an angle of 45 degrees toward the xy plane while the optical axis is rendered as an x axial direction. Therefore, an imagery position on the optical axis within this cross-section surface is not coincident with an imagery position within a cross-section surface perpendicular to this cross-section surface. A reason why such an astigmatism difference is produced is that an astigmatic method is used for the focus servo. Since the astigmatism method is a frequently used method and its principle is also well known, its descriptions are herein omitted.

The light 80c is converged on the optical axis near the light-receiving sensor 60 by the collimator lens 34 and the cylindrical lens 58. A reason that a term “converged” is used instead of “focused” is that since the light converged in the light-receiving sensor 60 by the astigmatism method has the astigmatic difference, it is not focused. The light-receiving sensor 60 is provided at an approximate intermediate position of respective imagery points on two cross-section surfaces defined by the above-described cylindrical lens 58.

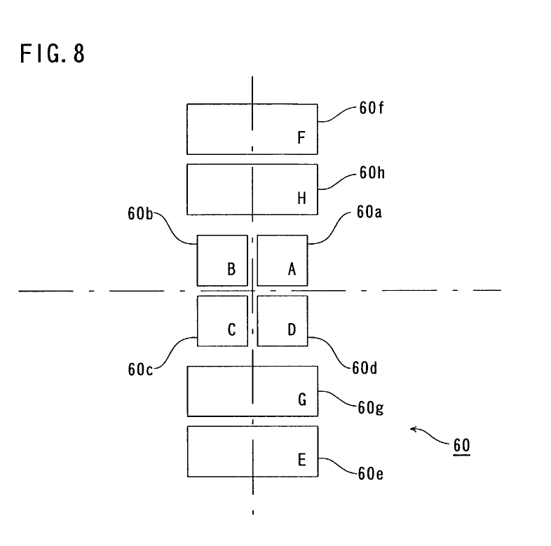

The light 80c is converged into four-divided sensors 60a, 60b, 60c and 60d arranged on the optical axial position shown in FIG. 8. The light-receiving sensor 60 is divided into four parts so as to reproduce a recorded signal, and at the same time, to be used for the focus servo. However, its operation is well-known, and therefore, descriptions are herein omitted.

Next, referring to FIG. 5-FIG. 7, a flow of ± primary light is described. The principal rays 64a and 64b of ± primary light that are a diffused light emitted from the virtual light source are incident on the collimator lens 34, having a gradient with respect to the optical axis, and proceeds having the same gradient as the optical axis after being converted into the parallel light, and directions thereof are changed by the reflection mirror 38, and imaged by the object lens 40 on the disk 12 as the sub-beams. In the Figures, the lights 68a and 68b represent the ± primary light which transit a center of the collimator, and the lights 72a and 72b represent the ± primary light which transit a center of the object lens.

The ± primary lights 72a and 72b are focused on the signal surface of the disk 12 at locations in a longitudinal direction of the track of the disk 12 from the optical axis and oppositely distant with each other. The reflected lights 76a and 76b are converted into the parallel light by the object lens 40, and directions thereof are the same as when irradiated. Then, the lights are converged on the light-receiving sensor 60 by the collimator lens 34 and the cylindrical lens 58 (80a, 80b). A reason why a term “converged” is used instead of “focused” is the same as in the above. The lights 80a and 80b represent a direction of the light which transits a center of the cylindrical lens, and converged on an extension thereof.

The lights 80a and 80b are incident into two-divided sensors 60e, 60f, 60g and 60h oppositely distant with each other toward the y direction from the optical axis as shown in FIG. 8. These two-divided sensors are sensors used for detecting de-track of the sub-beams in the above-described differential push-pull method. Since its dividing direction is included in a principle similar to the above, and well known, the descriptions are herein omitted.

Subsequently, the tilt servo is described. Firstly, a deterioration of the spot on the signal surface is described in respective cases that the disk 12 is tilted and the object lens 40 is tilted so as to describe a method which compensates or cancels an influence of the disk tilt by the lens tilt. Next, an optical route in this embodiment is described, and then, a detection method of the tilt is described. Furthermore, an operation of the tilt servo is described.

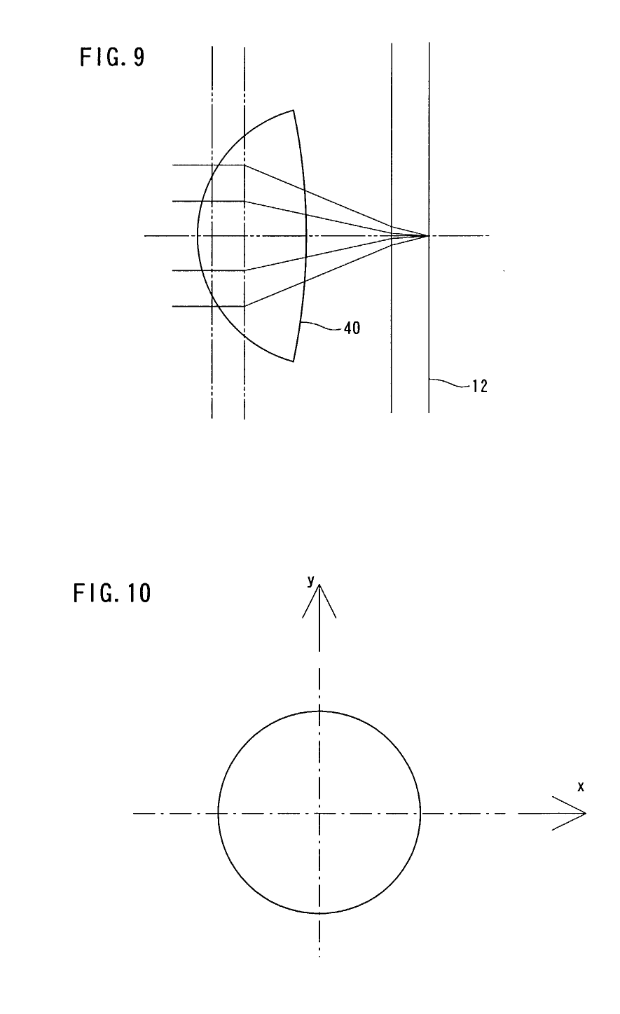

Firstly, a spot in a case that only the disk 12 is tilted is considered. FIG. 9 shows a state of a ray in a case of absence of the tilt. Since the object lens 40 is designed with a spherical aberration so that a spherical aberration is generated by a disk thickness can be canceled, the spherical aberration is not generated on the spot on the signal surface of the disk 12. FIG. 10 is a pattern diagram showing an imagery spot on the disk signal surface observed from an opposite side of the object lens in this case, and a condensing center of the light ray distant from the optical axis is coincident with the imagery center of a paraxial ray.

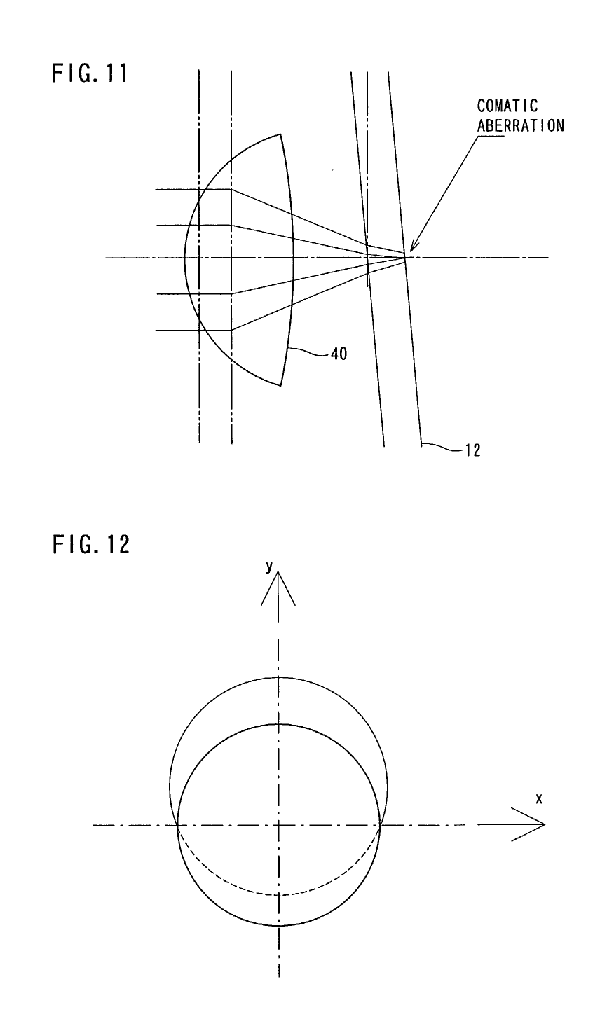

A state of a light in a case that the disk 12 is tilted is shown in FIG. 11. An imagery spot on the disk signal surface observed from an opposite side of the object lens, which is in this case, is shown in FIG. 12. As understood from FIG. 12, a condensing center of the light ray distant from the optical axis is distant toward a side that an interval or space between the disk 12 and the object lens 40 is narrowing from the imagery center of the paraxial ray by the tilt of the disk 12. This state is a state that the comatic aberration is generated.

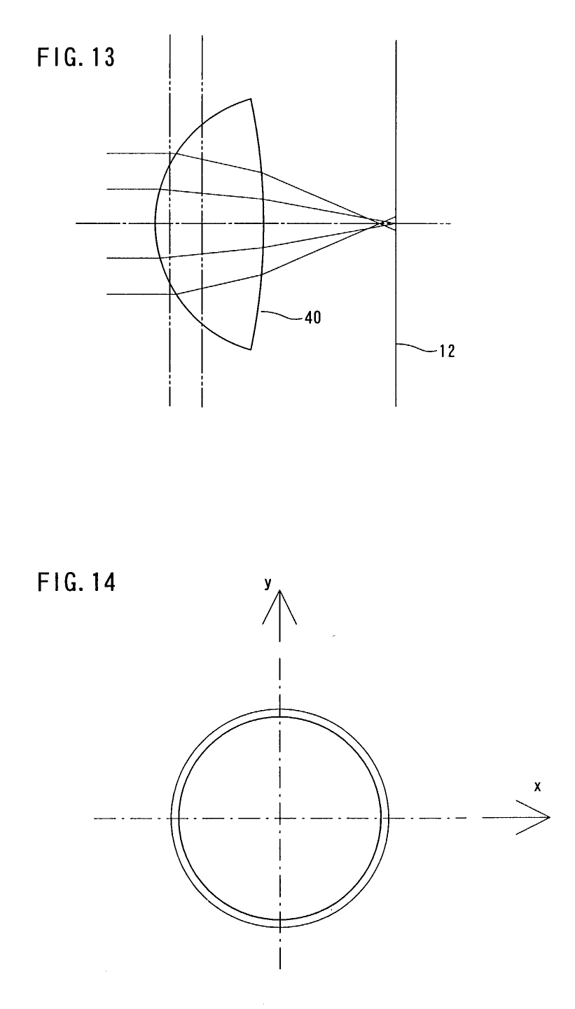

Nest, a spot in a case that only the object lens 40 is tilted is considered. FIG. 13 shows a state of a ray in a case of absence of the lens tilt. In FIG. 13, it is assumed that there is no disk thickness in order to consider only an influence of the object lens tilt. On the other hand, the lens is simply a spherical lens, and the spherical aberration is produced accordingly. FIG. 14 is a pattern diagram showing an imagery spot on the disk signal surface observed in this case from an opposite side of the object lens 40, and the condensing center of the light ray distant from the optical axis is coincident with the imagery center of the paraxial ray.

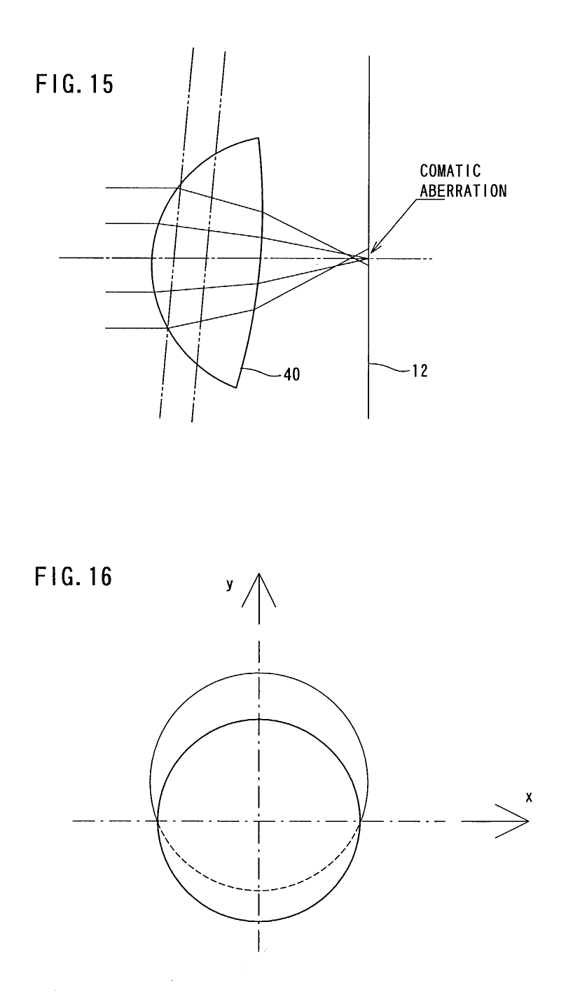

Contrary thereto, FIG. 15 shows a state of the light ray in a case that the object lens 40 is tilted. FIG. 16 shows an imagery spot on the disk signal surface observed in this case from an opposite side of the object lens 40. In this case, similar to the preceding disk tilt case (FIG. 12), the condensing center of the light ray distant from the optical axis is condensed toward a side which the interval or space between the disk 12 and the object lens 40 is narrowing by the tilt of the object lens 40 from the imagery center of the paraxial ray. This state is a state that the comatic aberration is generated.

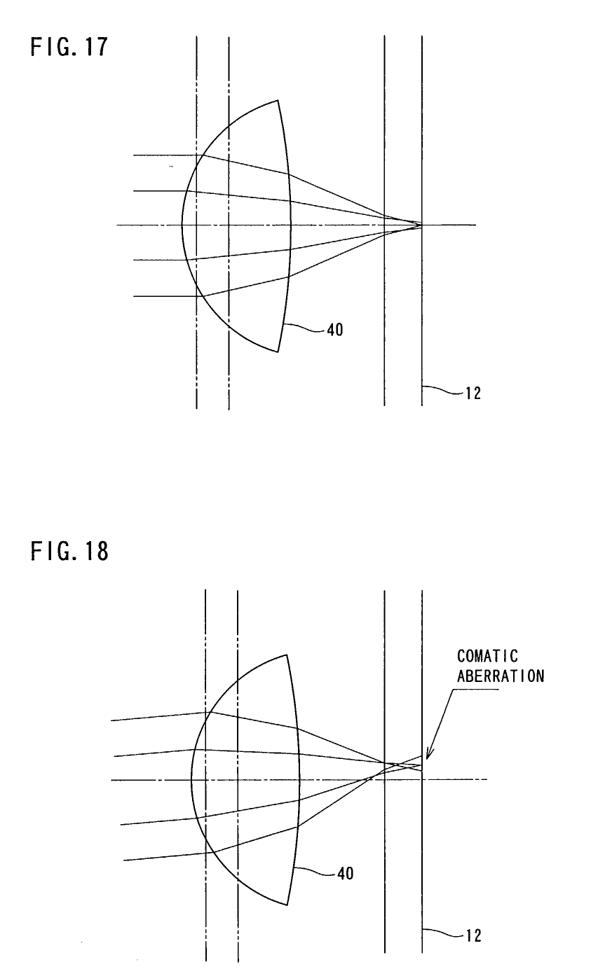

Furthermore, a spot in a case that the light ray incident to the object lens 40 is tilted is considered. In this case, there are influences of both the lens tilt and the disk tilt. A state of the light ray in a case of absence of the light ray tilt is the same as in the preceding FIG. 13. However, the object lens 40 is assumed to be a spherical lens which finds easy to track the light ray, and in addition, the disk 12 has a thickness, and in this case, a spherical aberration is thus generated on the spot on the disk signal surface as shown in FIG. 17. The imagery spot on the disk signal surface observed in this case from an opposite side of the object lens 40 is the same as in the preceding FIG. 14, and the condensing center of the light ray distant from the optical axis is coincident with the imagery center of the paraxial ray.

In contrary thereto, FIG. 18 shows a state of a light ray in a case that the incident light is tilted. In this case, the comatic aberration is generated in the imagery on the signal surface, and this results in such the spot as in the preceding FIG. 16 if the imagery spot on the disk signal surface is observed from an opposite side of the object lens 40. That is, the gradient of the light ray brings the condensing center of the light ray, distant from the optical axis distant, toward an incidence light proceeding direction side from imagery center of the paraxial ray, allowing the comatic aberration to be produced.

It may be appropriate to apply the tilt to the object lens 40 toward an opposite direction of FIG. 15 in order to compensate or cancel the comatic aberration generated by the disk tilt as shown in FIG. 11. This means that the object lens 40 is slanted toward such a direction that the object lens 40 is rendered parallel to the disk 12, however, if rendered completely parallel thereto, it will be the same state as the light ray tilt shown in FIG. 18, thus not compensating or canceling the comatic aberration. Therefore, a tilt state which stops short thereof is appropriate.

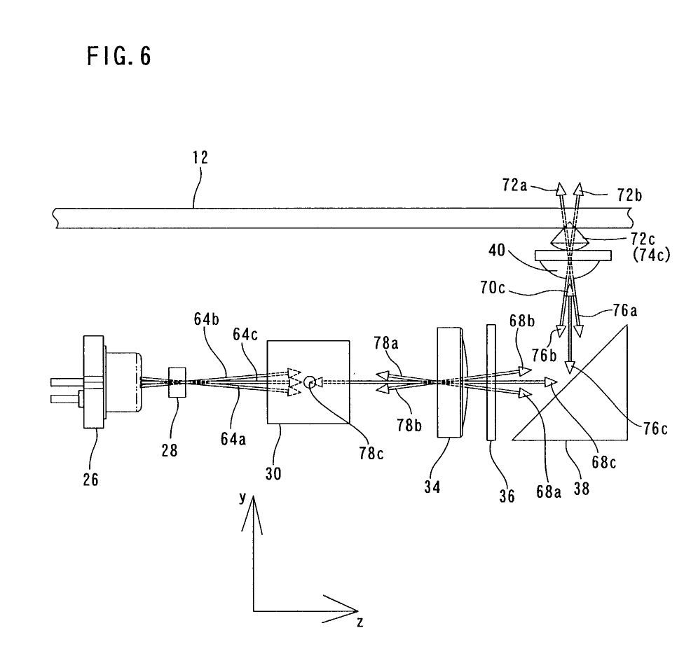

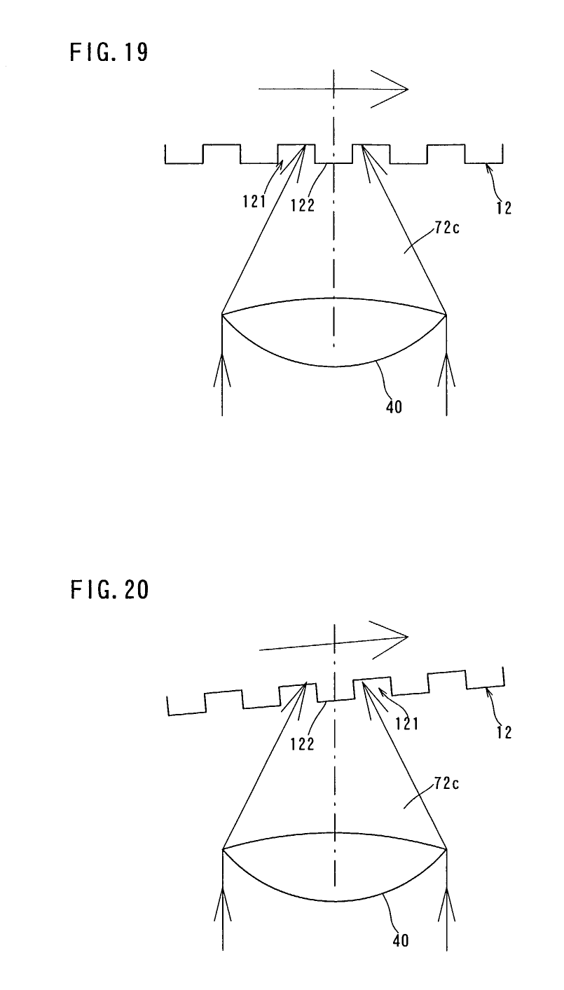

FIG. 19 shows a state that a beam spot 72c (FIG. 5, FIG. 6) is irradiated onto a groove 122 which is a groove on which a recording is made on the disk 12. In a case that a center of the groove 122 and a center of the spot 72c are coincident with each other, a light amount distribution of the reflected light of the disk is symmetric. However, in a case that the center of the spot is deviated from the center of the groove, it becomes asymmetric. The reflected light of the disk is focused onto the four-divided light-receiving sensors 60a-60d as described above, and this asymmetric characteristic makes light-receiving amounts of sensors (A+B ) and sensors (C+D ) in FIG. 8, that is, signal outputs such as current values or voltage values disequilibrium. A difference signal of electrical outputs from the sensors (A+B) and the electrical outputs from the sensors (C+D) is referred to as a push-pull signal. In FIG. 19, if the spot 72c transverses the groove 122 and a land 121 adjacent thereto toward an arrow direction, the push-pull signal becomes 0 (zero) at centers of the groove 122 and the land adjacent thereto. In the meantime, the disequilibrium of the light amount distribution becomes maximum, and the push-pull signal becomes maximum and minimum values so that a change in a sine-wave form with respect to a spot moving direction is shown.

It is noted that other push-pull signals including a sensor combination, a dividing direction, and so on are a well-known art and do not have a direct relation, thus its descriptions are herein omitted.

Herein, a principle of the tilt detection is described using FIG. 19 and FIG. 20. As described above, FIG. 19 is a sectional view which cuts the disk in a radial direction, and describes a states that the groove is irradiated by the beam from below. In addition, an amplitude of the push-pull signal produced when the beam traverses the groove in a state of presence of the disk tilt as shown in FIG. 20 becomes smaller compared to the amplitude in a case of absence of the disk tilt shown in FIG. 19. This is probably due to a fact that the beam spot becomes large as a result of the disk tilt so that a modulation factor of the push-pull signal is rendered smaller. Therefore, in a case that the light is irradiated parallel to the optical axis of the object lens 40, it is possible to mention that a state of an angle with its amplitude rendered maximum as a result of an examination of a change of the amplitude when a gradient of the disk 12 is changed is a state that the disk is perpendicular to the optical axis.

In a case that the optical disk apparatus 10 of this embodiment has a mechanism that subjects the disk to the tilt, it is possible to find or evaluate the angle at which the disk becomes perpendicular to the optical axis by actually slanting the disk for each radial location.

Herein, its specific method is described. The pick-up is moved at such intervals that it is possible to recognize a state of a curvature of the disk in between an inner most periphery and an outer most periphery in a radial direction. A focus servo is activated in such as manner that the beam spot on the disk is being focused. At this time, a tracking server is not activated, and therefore, the beam spot does not follow the groove or the pit array, thus resulting in a state of traversing them due to an eccentricity of the disk.

Pointed out firstly is a method, which the disk is slanted by a certain angle in a radial direction, and the amplitude of the push-pull signal as of that time is measured.

For the sake of simplicity, it may be possible that a measurement is performed at more than three angle locations, e.g. − (minus) 0.5 degrees, 0 degrees, and + (plus) 0.5 degrees with respect to a state designed to be 0 degrees in a certain radial location and the angle at which the amplitude is rendered maximum by a two-dimensional approximation is assumed. Or a trial-and-error method may also be possible. That is, in a case that two amplitudes are not the same in quantity when the disk is slanted in a radial direction by an angle of the same amount toward a mutually opposite direction from an initial reference angle, the reference angle is slightly moved and the measurement is performed once again, which is repeated until the two amplitudes become the same in quantity. When the same quantity is obtained, the reference angle is determined as a disk angle at which the push-pull signal amplitude is rendered maximum.

Using these methods, a pair data cluster of each radius and the disk angle at which and the push-pull signal amplitude become maximum or a physical amount equivalent thereto is obtained.

Actually, it is difficult to determine the gradient of the disk 12 by an angle in an inner side of the optical disk apparatus 10, and thus it is substituted by an input value correlated with the gradient in a mechanism that tilts the disk 12. In a mechanism that changes the gradient of the disk by an oscillation of the cam 88 in the FIG. 3 embodiment, for example, the number of input pulses in a case of driving the cam by a pulse motor, or pulse outputs from a rotary encoder that show a rotation angle location in a case of the cam to which the motor is attached are equivalent to the input value.

Then, in a case of performing a tilt control, assumed from the data cluster is the disk angel at which the push-pull signal amplitude becomes maximum, which is equivalent to its radial location, in recording or reproducing a signal at an arbitrary radial location.

Or the disk angle at which the push-pull signal amplitude becomes maximum in its radius by substituting by data at a radial location nearest to an arbitrary radius, or a physical amount equivalent thereto is assumed.

In recording and reproducing the signal at an arbitrary radial location, the disk gradient is set in such a manner that the disk angle at which the push-pull signal amplitude becomes maximum in the radial location, and a recording or a reproducing is performed.

With respect to a method that actually adjusts the gradient of the disk, various kinds of prior arts have been reported, and the present invention does not adhere to a specific method.

[Second Embodiment]

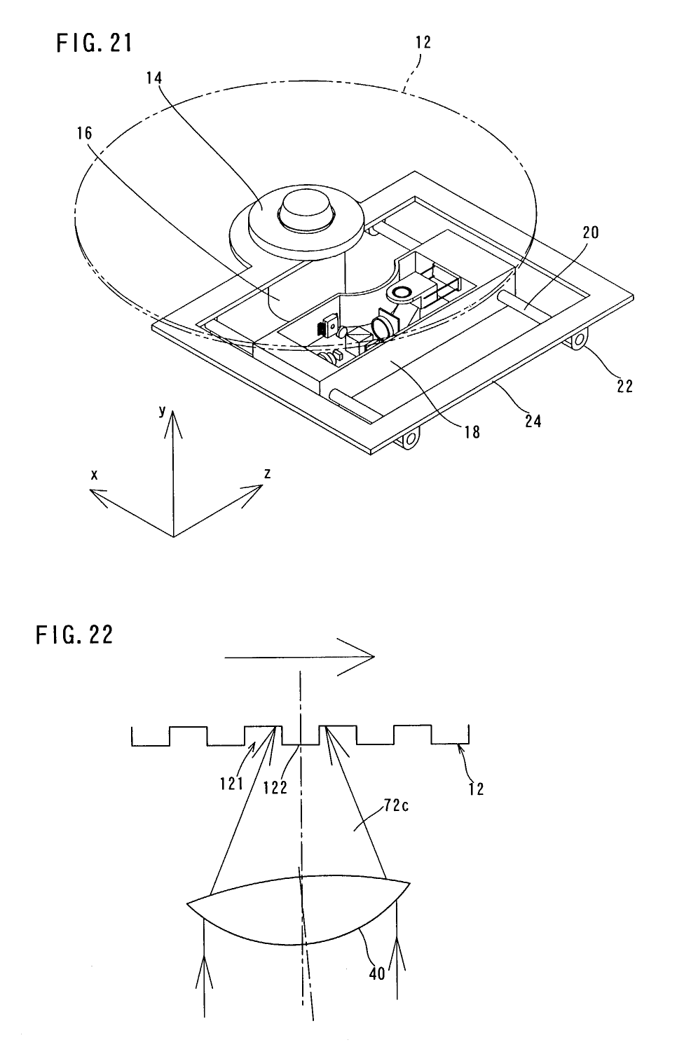

Referring to FIG. 21, in an optical disk apparatus 10 shown in FIG. 25, a disk 12 that is a recording/reproducing medium of signals is held by a holding portion 14, rotated by a spindle motor 16, and received an irradiation of light from an optical pick-up 18, thereby recording a signal to the disk 12 or reproducing the signal from the disk 12. The optical pick-up 18 is held to be movable toward an axial direction of a shaft 20 by a shaft 20a, and the shaft 20 is held by a shaft holder 22. The shaft holder 22 is fixed onto a shaft holder chassis 24.

Descriptions regarding the recording/reproducing method to the disk 12, the focus servo, and the tracking servo are completely the same as in the first embodiment, thus herein omitted.

In addition, an optical system to which the present invention is applied slightly differs depending on various kinds of recording/reproducing methods. Although an optical system of a DVD-R/RW is used as an example in order to describe an embodiment, it is not limited thereto.

An amplitude of the push-pull signal produced when the beam 72c traverses the groove in a state that a lens tilt is present as shown in FIG. 21 becomes smaller compared to the amplitude in a state that the lens tilt is absent as shown in FIG. 19. This is probably due to a fact that the beam spot becomes large as a result of the lens tilt, and a modulation factor of the push-pull signal becomes smaller. Therefore, in a case that the light perpendicular to the disk is incident on the object lens 40, it is possible to determine that a state of an angle with its amplitude rendered maximum as a result of an examination of a change of the amplitude when a gradient of the object lens is changed is a state that the optical axis of the object lens is parallel to the incident light and perpendicular to the disk.

In a case that the optical disk apparatus 10 of the embodiment has a mechanism that tilts the lens, it is possible to find or evaluate an angle at which the disk becomes perpendicular to the optical axis for each disk radial location.

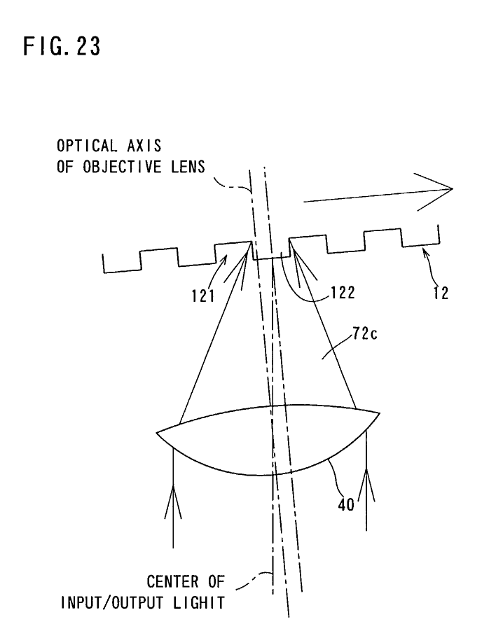

As shown in FIG. 23, it is described above that it is possible to remove the comatic aberration from the beam spot on the disk by slating the object lens in a slanted disk direction toward the same direction by not the same amount. If the object lens is slanted toward an completely opposite direction by the same amount from this state, a coma is generated in these two states so that the spot size becomes large, and as a result, the modulation factor of the push-pull signal becomes small, which reduces the amplitude thereof. However, since a state that the comatic aberration is removed intends to be a system symmetric to the optical axis of the object lens, a situation of generating the comatic aberration on the spot in the two states differs, and as a result, a reducing amount of the amplitude is not the same.

Its specific method is herein described. The pick-up is moved at such intervals that it is possible to recognize a state of a curvature of the disk in between the inner most periphery and the outer most periphery in the radial direction. A focus servo is activated in such as manner that the beam spot on the disk is focused. A tracking server is not activated, and the beam spot does not follow the groove or the pit array, thus resulting in a state of traversing them due to an eccentricity of a disk.

Pointed out firstly is a method, which the lens is slanted by a certain angle, and the amplitude of the push-pull signal as of that time is measured. To be simplified, it may be possible that a measurement is performed at more than three angle locations, e.g. − (minus) 0.5 degrees, 0 degrees, and + (plus) 0.5 degrees with respect to a state designed to be 0 degrees in a certain radial location and the angle at which the amplitude is rendered maximum by a two-dimensional approximation is assumed.

Or a trial-and-error method may also be possible. That is, in a case that a difference of the two amplitudes is not a reference value actually measured and determined through the considerations of the aforesaid non-symmetricity when the lens is slanted in a radial direction by an angle of the same amount toward a mutually opposite direction from an initial reference angle, the reference angle is slightly moved and the measurement is performed once again, which is repeated until the difference of the two amplitudes approximately become the reference value. When the difference becomes the reference value, the reference angle is determined as a lens angle at which the comatic aberration can be eliminated from the beam spot.

Using these methods, a pair data cluster of each radius and the angle of the object lens at which and the push-pull signal amplitude becomes maximum or a physical amount equivalent thereto is obtained.

Actually, in an inner side of a disk drive apparatus, it is difficult to determine the gradient of the object lens by an angle, thus it is substituted by an input value correlated with the gradient in a mechanism that tilts the object lens 12. In a mechanism that changes an electromagnetic force that effects a coil by a current that flows through the coil fixed on the object lens in a magnetic field, and as a result, the object lens is tilted, a current value or applied voltage are equivalent to the input value.

The angel of the object lens at which the push-pull signal amplitude becomes maximum, which is equivalent to its radial location from the data cluster is assumed, in recording or reproducing a signal at an arbitrary radial location. Or the angle of the object lens at which the push-pull signal amplitude becomes maximum at its radius by substituting by data at a nearest radial location from an arbitrary radius or a physical amount equivalent thereto is assumed.

In recording and reproducing the signal at an arbitrary radial location, the gradient of the object lens is set in such a manner that the angle of the object lens at which the push-pull signal amplitude becomes maximum in the radial location, and a recording or a reproducing is performed.

With respect to a method that actually adjusts the gradient of the object lens, various kinds of prior arts have been reported, and the present invention does not adhere to a specific method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical disk apparatus, comprising:
an optical pick-up that irradiates a beam spot onto a disk through an object lens, receives a reflected light from the disk by a two-divided light-receiving element, and has a function that detects a difference signal of electrical outputs that reflect a light-receiving amount of each light-receiving element;
a mechanism capable of changing a relative angle of said disk with respect to said object lens in a radial direction of said disk; and
a detection means that evaluates a gradient angle of said disk at which an amplitude of said difference signal becomes maximum in an arbitrary radial location.

2. An optical disk apparatus according to claim 1, further comprising an angle setting means that sets the gradient angle of said disk in accordance with a radius that intends to perform a recording/reproducing a signal on the basis of said radial location and the gradient angle of said disk.

3. An optical disk apparatus provided with an optical pick-up that irradiates a beam spot onto a disk through an object lens, receives a reflected light from the disk by a two-divided light-receiving element, and has a function that detects a difference signal of electrical outputs that reflect a light-receiving amount of each light-receiving element and a mechanism capable of changing a gradient angle of said object lens in a radial direction of said disk, characterized in that said apparatus further comprises a detection means that evaluates a gradient angle of said object lens at which an amplitude of said difference signal becomes maximum in an arbitrary radial location.

4. An optical disk apparatus according to claim 3, further comprising an angle setting means that sets the gradient angle of said object lens in accordance with a radius that intends to perform a recording/reproducing a signal on the basis of said radial location and the gradient angle of said object lens.

5. A method of recording/reproducing a signal in an optical disk apparatus provided with an optical pick-up that irradiates a beam spot onto a disk through an object lens, receives a reflected light from the disk by a two-divided light-receiving element, and has a function that detects a difference signal of electrical outputs that reflect a light-receiving amount of each light-receiving element and a mechanism capable of changing a relative angle of said disk with respect to said object lens in a radial direction of said disk, comprising following steps of
(a) evaluating a gradient angle of said disk at which an amplitude of said difference signal becomes maximum in an arbitrary radial location, and
(b) setting the gradient angle of said disk in accordance with a radius that intends to perform a recording/reproducing a signal on the basis of said radial location and the gradient angle of said disk.

6. A method of recording/reproducing a signal in an optical disk apparatus provided with an optical pick-up that irradiates a beam spot onto a disk through an object lens, receives a reflected light from the disk by a two-divided light-receiving element, and has a function that detects a difference signal of electrical outputs that reflect a light-receiving amount of each light-receiving element and a mechanism capable of changing a gradient angle of said object lens in a radial direction of said disk, comprising following steps of
(a) evaluating a gradient angle of said object lens at which an amplitude of said difference signal becomes maximum in an arbitrary radial location, and
(b) setting the gradient angle of said object lens in accordance with a radius that intends to perform a recording/reproducing a signal on the basis of said radial location and the gradient angle of said object lens.
